(19) United States
(12) Patent Application Publication
(10) Pub. No.: US 2024/0203282 A1
(43) Pub. Date: Jun. 20, 2024

(54) COGNITIVE FUNCTION TESTING DEVICE AND STORAGE MEDIUM

(71) Applicant: OMRON HEALTHCARE CO., LTD., Muko-shi (JP)

(72) Inventors: Miki OKUGAWA, Kyoto (JP); Yuka SUZUKI, Kyoto (JP); Hideyuki KOBAYASHI, Kyoto (JP)

(21) Appl. No.: 18/591,996

(22) Filed: Feb. 29, 2024

Related U.S. Application Data
(63) Continuation of application No. PCT/JP2023/004198, filed on Feb. 8, 2023.

(30) Foreign Application Priority Data
Jun. 20, 2022 (JP) 2022-098910

(51) Int. Cl. G09B 7/02

(52) U.S. Cl. CPC G09B 7/02

(57) ABSTRACT

A cognitive function testing device includes: a controller configured to execute a questioning process of outputting a first word to be memorized to an examinee, prompting the examinee to repeat the first word, and detecting a second word from a repeated voice of the examinee, an answer reception process of prompting the examinee to utter a word memorized by the examinee through the questioning process, and detecting a third word from an utterance voice of the examinee, and a result output process of outputting a result of determination based on the first word, the second word, and the third word.

### CROSS-REFERENCE TO RELATED APPLICATIONS

This application is a continuation of PCT application No. PCT/JP2023/004198, which was filed on Feb. 8, 2023 based on Japanese Patent Application No. 2022-098910 filed on Jun. 20, 2022, the contents of which are incorporated herein by way of reference.

### BACKGROUND

The present disclosure relates to a cognitive function testing device and a storage medium storing a cognitive function testing program.

In the related art, there is known a cognitive function testing system in which an examinee is caused to memorize a plurality of pictures displayed on a touch panel and to answer the memorized pictures in answer fields (JP2021-177224A).

In the cognitive function testing system of JP2021-177224A, four pictures used for a question are displayed on one screen of the touch panel, and when the examinee memorizes the four pictures, the examinee is asked to say “I have memorized them”. Then, this process is repeated until the examinee memorizes 16 pictures in total. Next, answer fields 1 to 16 corresponding to the 16 pictures are displayed on the touch panel, and the examinee is asked to write by hand in order in the answer fields what the memorized 16 pictures are.

However, in the case of the test in JP2021-177224A, the examinee is not pronouncing the displayed picture (word), but only saying “I have memorized”, and thus it is not possible to confirm whether the pictures are memorized correctly. In addition, since the examinee is asked to answer by handwriting the memorized pictures, handwriting input is cumbersome for the examinee, and it takes time to complete the answers. Therefore, there is room for improvement in a cognitive function test in the related art.

Aspects of the present disclosure relate to providing a cognitive function testing device and a storage medium storing a cognitive function testing program that are capable of improving test accuracy.

### SUMMARY

According to an aspect of the present disclosure, there is provided a cognitive function testing device, including:
a controller configured to execute
a questioning process of outputting a first word to be memorized to an examinee, prompting the examinee to repeat the first word, and detecting a second word from a repeated voice of the examinee,
an answer reception process of prompting the examinee to utter a word memorized by the examinee through the questioning process, and detecting a third word from an utterance voice of the examinee, and
a result output process of outputting a result of determination based on the first word, the second word, and the third word.

### BRIEF DESCRIPTION OF DRAWINGS

FIG. 1 is a diagram showing an example of an information terminal 10 constituting a cognitive function testing device according to an embodiment;

FIG. 2 is a diagram showing an example of a hardware configuration of the information terminal 10;

FIG. 3 is a flowchart showing an example of an overall process procedure of a cognitive function test;

FIG. 4 is a flowchart showing an example of a questioning process of the cognitive function test;

FIG. 5 is a flowchart showing the example of the questioning process of the cognitive function test;

FIG. 6 is a diagram showing an example of a questioning list in which words to be memorized are set;

FIG. 7 is a diagram showing an example of an image to be memorized which is displayed in the questioning process;

FIG. 8 is a diagram showing an example of an image for prompting repetition of the memorized object in the questioning process;

FIG. 9 is a diagram showing an example of an image for prompting re-repetition of the memorized object in the questioning process;

FIG. 10 is a diagram showing an example of a correct answer list in which correct words are set;

FIG. 11 is a diagram showing an example of an image displayed in a training process;

FIG. 12 is a diagram showing an example of an image displayed at the start of an answer reception process;

FIG. 13 is a diagram showing an example of an answer reception image displayed in the answer reception process;

FIG. 14 is a diagram showing an example of an answer determination image displayed in the answer reception process;

FIG. 15 is a diagram showing an example of an image displayed in a result output process;

FIG. 16 is a flowchart showing a modification of the questioning process; and

FIG. 17 is a diagram showing a modification of a controller.

### DESCRIPTION OF EMBODIMENTS

Hereinafter, embodiments according to aspects of the present disclosure will be described with reference to the drawings.

### § 1 Application Example

### <Information Terminal 10>

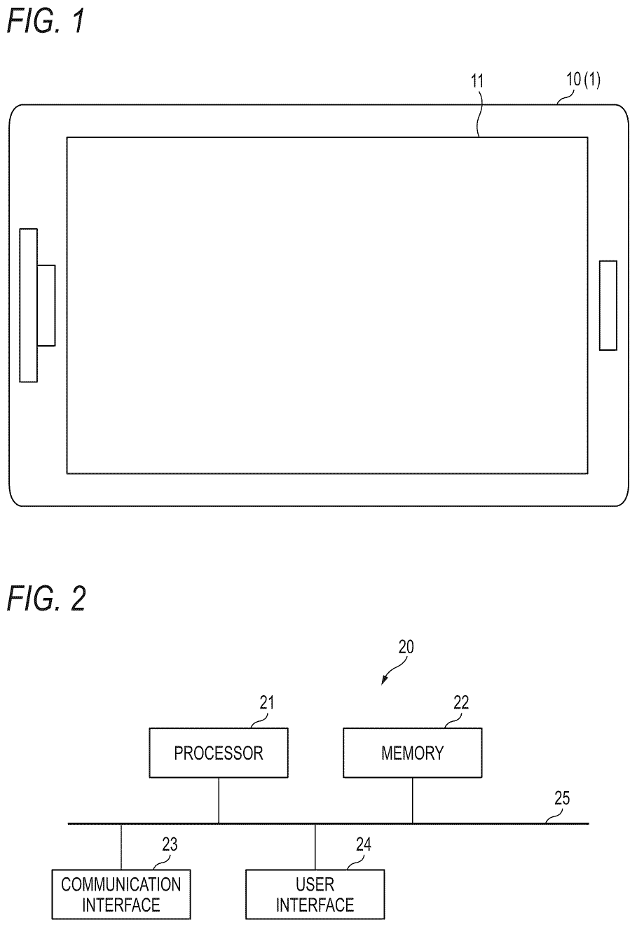

FIG. 1 is a diagram showing an example of an information terminal 10 constituting a cognitive function testing device 1 in the present disclosure. The information terminal 10 includes a display screen 11 on which test information for performing a cognitive function test is displayed. The information terminal 10 is, for example, a terminal such as a smartphone or a tablet. The display screen 11 also functions as a touch panel capable of inputting the test information. In addition, the information terminal 10 includes a speaker (not shown) that outputs the test information by voice.

### § 2 Configuration Example

### <Hardware Configuration of Cognitive Function Testing Device 1>

FIG. 2 is a diagram showing an example of a hardware configuration of the cognitive function testing device 1. The hardware of the cognitive function testing device 1 may be implemented by, for example, an information processing device 20 shown in FIG. 2. The information processing device 20 includes a processor 21, a memory 22, a communication interface 23, and a user interface 24. The processor 21, the memory 22, the communication interface 23, and the user interface 24 are connected by, for example, a bus 25.

The processor 21 is a circuit that performs a signal process, and is, for example, a central processing unit (CPU) that controls the entire information processing device 20. The processor 21 is an example of a controller of the present disclosure. The processor 21 may be implemented by another digital circuit such as a field programmable gate array (FPGA) or a digital signal processor (DSP). The processor 21 may be implemented by combining a plurality of digital circuits.

The memory 22 includes, for example, a main memory and an auxiliary memory. The main memory is, for example, a random access memory (RAM). The main memory is used as a work area of the processor 21.

The auxiliary memory is, for example, a nonvolatile memory such as a magnetic disk, an optical disk, or a flash memory. The auxiliary memory stores various programs for operating the information processing device 20. The program stored in the auxiliary memory is loaded into the main memory and executed by the processor 21.

The auxiliary memory may include a portable memory that is removable from the information processing device 20. Examples of the portable memory include a memory card such as a universal serial bus (USB) flash drive and a secure digital (SD) memory card, and an external hard disk drive.

The communication interface 23 is a communication interface that performs network communication with the outside (for example, an external server) of the information processing device 20. The communication interface 23 is controlled by the processor 21.

The user interface 24 includes, for example, an input device that receives an operation input from an examinee who receives the cognitive function test and an output device that outputs information to the examinee. The input device may be implemented by, for example, a touch panel. The output device may be implemented by, for example, a display or a speaker. The user interface 24 is controlled by the processor 21.

For example, in the cognitive function test, the processor 21 executes a questioning process of questioning about a “word to be memorized” that is a word to be memorized by the examinee, an answer reception process of detecting an “uttered memorized word” from a voice uttered by the examinee, and a result output process of outputting a result of the cognitive function test. The processor 21 may execute, for example, a training process between the questioning process and the answer reception process.

### <Questioning Process>

In the questioning process, the processor 21 outputs the “word to be memorized” to the examinee. For example, the processor 21 reproduces an image of the word to be memorized via the display screen 11 of the information terminal 10. In addition, for example, the processor 21 outputs the word to be memorized in voice via the speaker of the information terminal 10 or displays the word to be memorized in text via the display screen 11. The word to be memorized that is to be output is stored in the memory 22 as image information, voice information, and text information. The processor 21 outputs the word to be memorized and prompts the examinee to repeat the word to be memorized. The processor 21 recognizes a voice repeated by the examinee and detects a “repeated word” from the repeated voice.

When the repeated word detected from the repeated voice of the examinee is different from the word to be memorized output to the examinee, the processor 21 prompts the examinee to re-repeat the word to be memorized. The processor 21 recognizes a voice re-repeated by the examinee and detects a “re-repeated word” from the re-repeated voice.

The processor 21 sequentially executes the above series of questioning processes for a plurality of words to be memorized. In the plurality of questioning processes, the processor 21 selects, based on a repeated word detected in the previous questioning process, a word to be memorized in the questioning process subsequent to the questioning process.

For example, the processor 21 selects the word to be memorized in the subsequent questioning process from words different from the repeated word detected in the previous questioning process. Specifically, it is assumed that when “nekutai (necktie)” is questioned as a word to be memorized in the previous questioning process, a repeated word “nikutai (physical body)” is detected from a repeated voice of the examinee. In this case, a word different from “nikutai (physical body)” is selected as a word to be memorized that is to be questioned in the subsequent questioning process so as not to overlap.

For example, the processor 21 changes the word to be memorized in the subsequent questioning process to a word that is different from the repeated word detected in the previous questioning process and that is in the same category as the word to be memorized set in advance in the subsequent questioning process. Specifically, it is assumed that the words to be memorized in the plurality of questioning processes are set in advance, and when “rimokon (remote controller)” is questioned as a word to be memorized in the previous questioning process, a repeated word “Lincoln” is detected from a repeated voice of the examinee, and a word “Lincoln” is included in the words to be memorized set in advance. In this case, a word to be memorized that is to be questioned in the subsequent questioning process is changed to a personal name that is a word different from “Lincoln” and that is in the same category as “Lincoln”.

For example, when the repeated word detected in the previous questioning process is different from the word to be memorized, the processor 21 selects the word to be memorized in the subsequent questioning process from a plurality of word candidates prepared in advance, based on the number of characters of the word candidate. Specifically, it is assumed that when “nekutai (necktie)” is questioned as a word to be memorized in the previous questioning process, a repeated word “nikutai (physical body)” is detected from a repeated voice of the examinee. In this case, it is determined that the voice repeated by the examinee is a voice that is likely to be erroneously recognized by a voice recognition side, and a word that is unlikely to be erroneously recognized, for example, a word having a large number of characters is selected from the word candidates as a word to be memorized in the subsequent questioning process.

For example, the processor 21 stores history information based on a detection result of a repeated word in a past cognitive function test in the memory 22 in association with the examinee. The processor 21 selects the word to be memorized in the questioning process based on the stored history information. Specifically, it is assumed that when “nekutai (necktie)” is questioned as a word to be memorized in the previous questioning process, a repeated word “nikutai (physical body)” is detected from a repeated voice of the examinee. In this case, the processor 21 determines that it is difficult for the examinee to pronounce a word “nekutai (necktie)”, and removes the word “nekutai (necktie)” from candidates of the word to be memorized that is to be questioned to the examinee.

### <Answer Reception Process>

In the execution of the questioning process, the processor 21 prompts the examinee to utter the word memorized by repetition of the examinee. However, during the answer reception process, information related to the word to be memorized is not output to the examinee. The processor 21 recognizes a voice uttered by the examinee and detects a “uttered memorized word” from the uttered voice.

### <Result Output Process>

The processor 21 outputs a determination result of the cognitive function test based on the output “word to be memorized”, the “repeated word” detected from the repeated voice of the examinee, and the “uttered memorized word” detected from the uttered voice of the examinee. For example, in the determination of the cognitive function test, when the uttered memorized word detected from the uttered voice of the examinee matches the word to be memorized that is questioned to the examinee, the processor 21 determines that an answer is correct. In the determination of the cognitive function test, when the uttered memorized word detected from the uttered voice of the examinee matches the repeated word detected from the repeated voice of the examinee, the processor 21 determines that the answer is correct.

In a case where the re-repeated word detected from the re-repeated voice of the examinee matches the repeated word detected from the repeated voice of the examinee, in the determination of the cognitive function test, when the uttered memorized word detected from the uttered voice of the examinee matches the repeated word detected from the repeated voice of the examinee in the questioning process, the processor 21 determines that the answer is correct.

In a case where the re-repeated word detected from the re-repeated voice of the examinee does not match the repeated word detected from the repeated voice of the examinee, in the determination of the cognitive function test, even if the uttered memorized word detected from the uttered voice of the examinee matches the repeated word detected from the repeated voice of the examinee in the questioning process, the processor 21 does not determine that the answer is correct.

In a case where the re-repeated word detected from the re-repeated voice of the examinee matches the word to be memorized that is questioned to the examinee, in the determination of the cognitive function test, even if the uttered memorized word detected from the uttered voice of the examinee matches the repeated word detected from the repeated voice of the examinee in the questioning process, the processor 21 does not determine that the answer is correct.

The word to be memorized is an example of a first word. The repeated word and the re-repeated word are examples of a second word. The uttered memorized word is an example of a third word.

### § 3 Operation Example

### <Operation of Cognitive Function Testing Device>

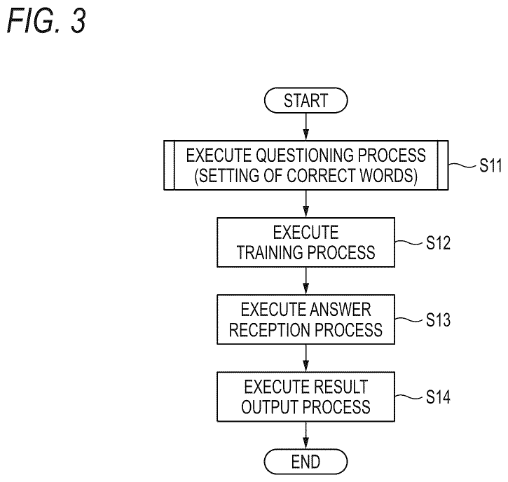

Next, an operation example of the cognitive function test of the cognitive function testing device 1 will be described with reference to FIGS. 3 to 15.

FIG. 3 is a flowchart showing an overall process procedure of the cognitive function test. As shown in FIG. 3, the processor 21 of the cognitive function testing device 1 performs the cognitive function test in the order of the questioning process (setting of correct words) in step S11, the training process in step S12, the answer reception process in step S13, and the result output process in step S14. The cognitive function test is started by a touch operation on the display screen 11 of the information terminal 10.

### <Questioning Process in Step S11>

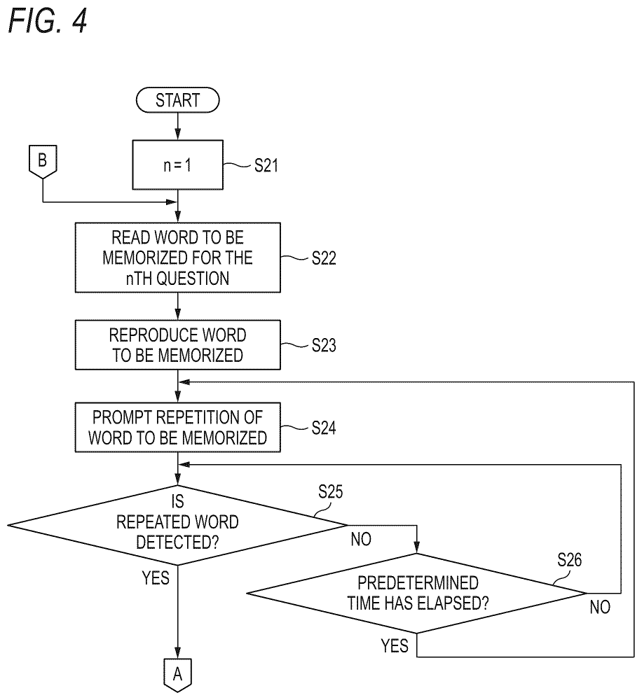

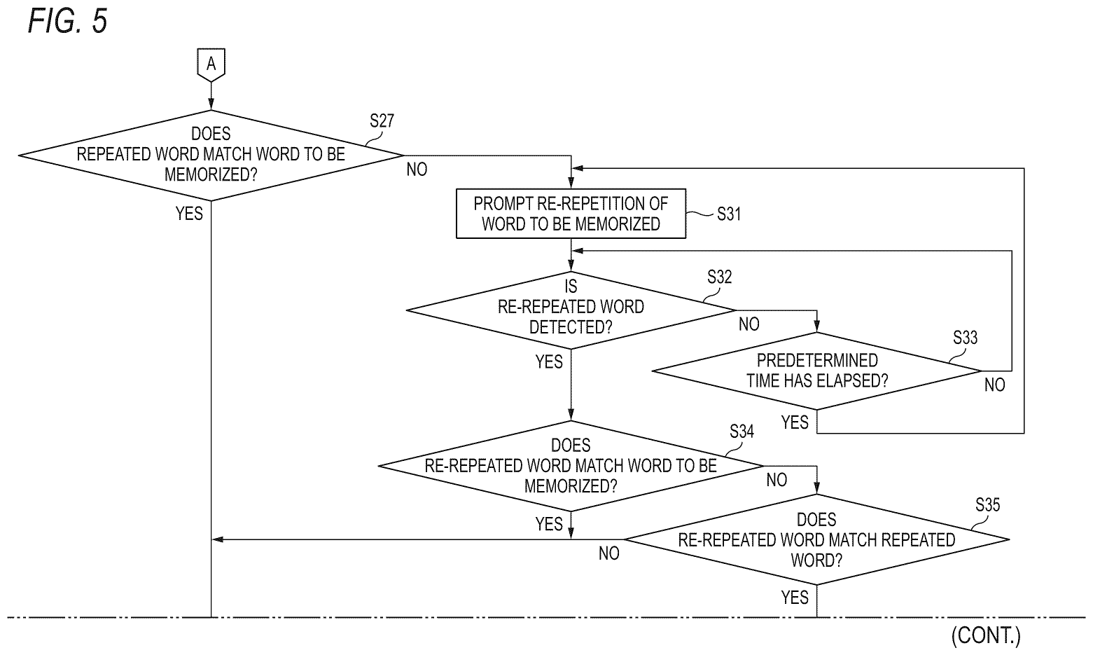

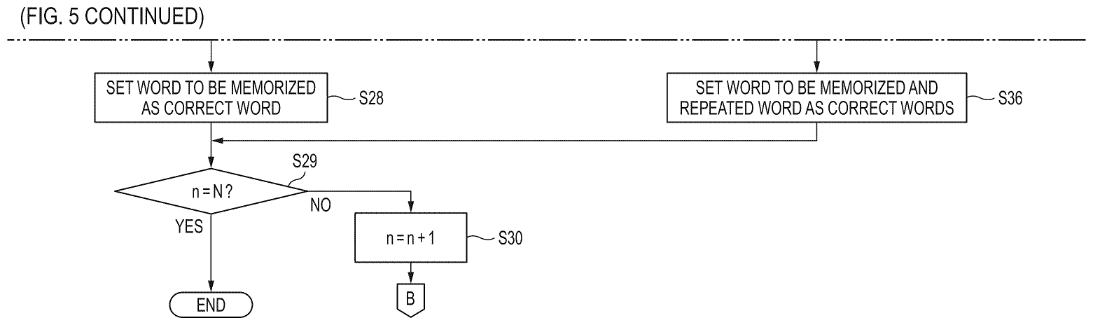

In the questioning process, the processor 21 executes processes shown in flowcharts of FIGS. 4 and 5.

First, the processor 21 sets n=1 indicating that the question is the first question to be questioned in the cognitive function test (step S21).

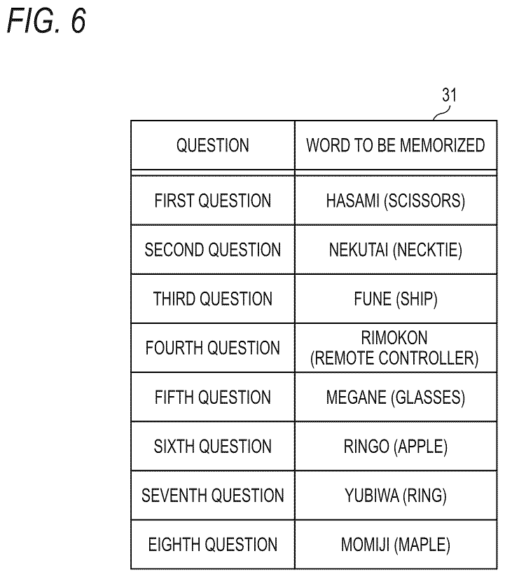

Next, the processor 21 reads image information and voice information on a word to be memorized for the first question from the memory 22 (step S22). For example, as shown in FIG. 6, the words to be memorized are set in advance as a questioning list 31 and stored in the memory 22. In this example, eight questions are set, from the first question to the eighth question. The words to be memorized are set such as “hasami (scissors)” for the first question, “nekutai (necktie)” for the second question, “fune (ship)” for the third question, “rimokon (remote controller)” for the fourth question, “megane (glasses)” for the fifth question, “ringo (apple)” for the sixth question, “yubiwa (ring)” for the seventh question, and “momiji (maple)” for the eighth question.

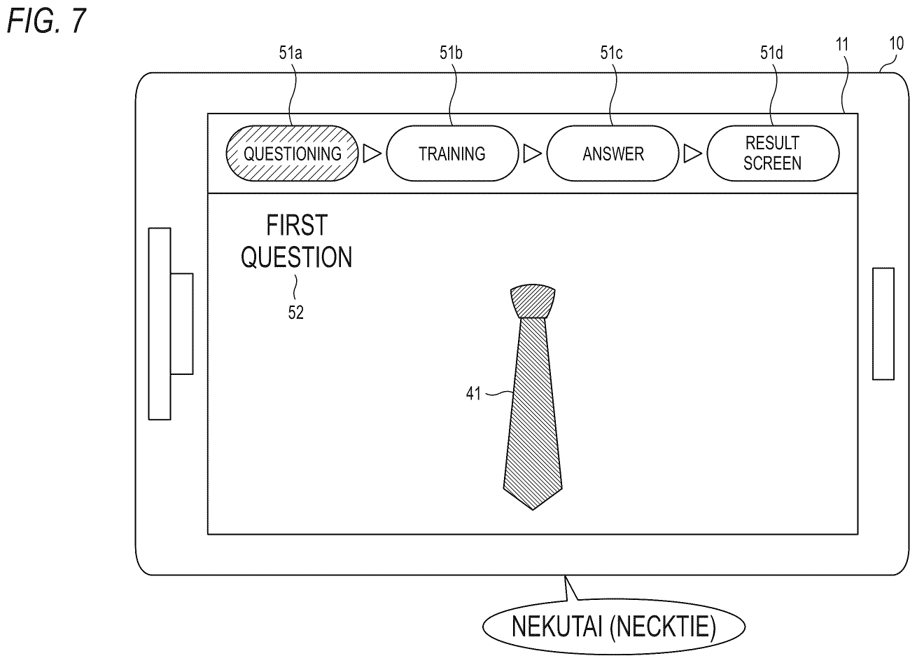

Next, the processor 21 reproduces the image information and the voice information on the word to be memorized that is read in step S22 (step S23). As shown in FIG. 7, the word to be memorized is reproduced on the information terminal 10. For example, the processor 21 outputs a voice, such as “nekutai (necktie)”, from the speaker while displaying a necktie image 41 on the display screen 11. The processor 21 displays, on the display screen 11, a questioning mark 51a for notifying that a current test process is the questioning process and a question number mark 52 for notifying that a current question is the first question.

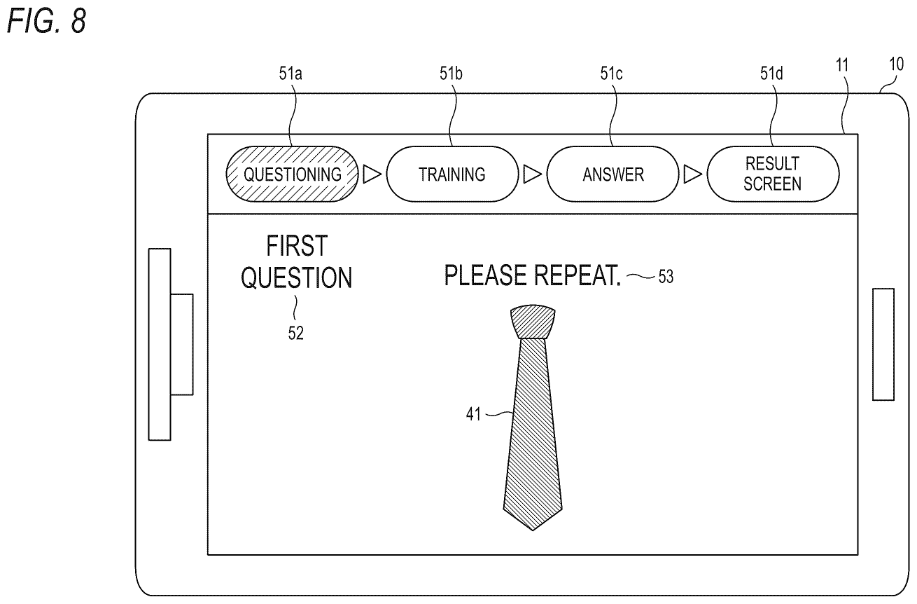

Next, the processor 21 prompts the examinee to repeat the word to be memorized that is reproduced in step S23 (step S24). For example, as shown in FIG. 8, the processor 21 prompts the examinee to repeat the word to be memorized, by displaying a comment 53 such as “PLEASE REPEAT” on the necktie image 41 of the display screen 11.

Next, the processor 21 determines whether a repeated word is detected from a voice repeated by the examinee (step S25).

In step S25, when the repeated word cannot be detected (step S25: No), the processor 21 determines whether a predetermined time has elapsed during which the repeated word cannot be detected (step S26). In step S26, when the predetermined time has not elapsed during which the repeated word cannot be detected (step S26: No), the processor 21 returns to step S25 and repeats each process. In step S26, when the predetermined time has elapsed during which the repeated word cannot be detected (step S26: Yes), the processor 21 returns to step S24 and repeats each process.

On the other hand, in step S25, when the repeated word may be detected (step S25: Yes), the processor 21 determines whether the detected repeated word matches the word to be memorized (step S27).

In step S27, when the repeated word matches the word to be memorized (step S27: Yes), the processor 21 sets the word to be memorized as a correct word (step S28). Specifically, when “hasami (scissors)” is questioned as a word to be memorized, “hasami (scissors)” is detected as a repeated word from a voice repeated by the examinee (“hasami (scissors)”=“hasami (scissors)”). The correct word is a word that is recognized to be correctly memorized when the uttered memorized word detected from the voice uttered by the examinee in the answer reception process in step S13 in FIG. 3 matches the correct word.

Next, the processor 21 determines whether the number of questions n questioned in this test reaches the final number of questions N (step S29). As shown in FIG. 6, eight questions are set in this example. Therefore, the processor 21 determines whether the number of questions questioned to the examinee reaches N=8.

In step S29, when the number of questions does not reach N=8 (step S29: No), the processor 21 sets n=n+1 (step S30), and returns to step S22 to proceed to the next question.

In step S29, when the number of questions reaches N=8 (step S29: Yes), the processor 21 ends the questioning process and proceeds to step S12 of FIG. 3.

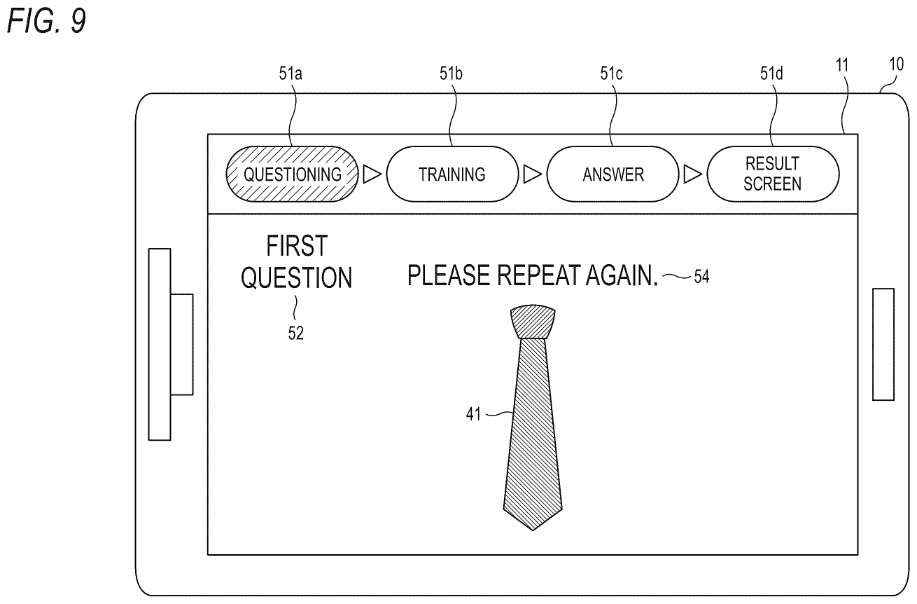

On the other hand, in step S27, when the repeated word does not match the word to be memorized (step S27: No), the processor 21 prompts the examinee to re-repeat the word to be memorized (step S31). For example, as shown in FIG. 9, the processor 21 prompts the examinee to re-repeat the word to be memorized, by displaying a comment 54 such as “PLEASE REPEAT AGAIN” on the necktie image 41 of the display screen 11.

Next, the processor 21 determines whether a re-repeated word is detected from a voice re-repeated by the examinee (step S32).

In step S32, when the re-repeated word cannot be detected (step S32: No), the processor 21 determines whether a predetermined time has elapsed during which the re-repeated word cannot be detected (step S33). In step S33, when the predetermined time has not elapsed during which the re-repeated word cannot be detected (step S33: No), the processor 21 returns to step S32 and repeats each process. In step S33, when the predetermined time has elapsed during which the re-repeated word cannot be detected (step S33: Yes), the processor 21 returns to step S31 and repeats each process.

On the other hand, in step S32, when the re-repeated word is detected (step S32: Yes), the processor 21 determines whether the detected re-repeated word matches the word to be memorized (step S34).

In step S34, when the re-repeated word matches the word to be memorized (step S34: Yes), the processor 21 proceeds to step S28 and sets the word to be memorized as the correct word. Specifically, when “hasami (scissors)” is questioned as a word to be memorized, “masami” is detected as a repeated word from a voice repeated by the examinee. Therefore, when the re-repetition is prompted, “hasami (scissors)” is detected as a re-repeated word from a voice re-repeated by the examinee (“hasami (scissors)”=>“masami”=>“hasami (scissors)”).

In step S34, when the re-repeated word does not match the word to be memorized (step S34: No), the processor 21 determines whether the re-repeated word matches the repeated word (step S35).

In step S35, when the re-repeated word matches the repeated word (step S35: Yes), the processor 21 sets the word to be memorized and the repeated word as correct words (step S36), and proceeds to step S29. Specifically, when “hasami (scissors)” is questioned as a word to be memorized, “masami” is detected as a repeated word from a voice repeated by the examinee. Therefore, when the re-repetition is prompted, “masami” is detected as a re-repeated word from a voice re-repeated by the examinee (“hasami (scissors)”=>“masami”=>“masami”).

In step S35, when the re-repeated word does not match the repeated word (step S35: No), the processor 21 proceeds to step S28 and sets the word to be memorized as the correct word. Specifically, when “hasami (scissors)” is questioned as a word to be memorized, “masami” is detected as a repeated word from a voice repeated by the examinee. Therefore, when the re-repetition is prompted, “sasami” is detected as a re-repeated word from a voice re-repeated by the examinee (“hasami (scissors)”=>“masami”=>“sasami”). When the re-repeated word does not match either the word to be memorized or the repeated word, the testing device may notify the examinee that the voice cannot be heard correctly and recommend that the examinee writes an answer by hand on a keyboard.

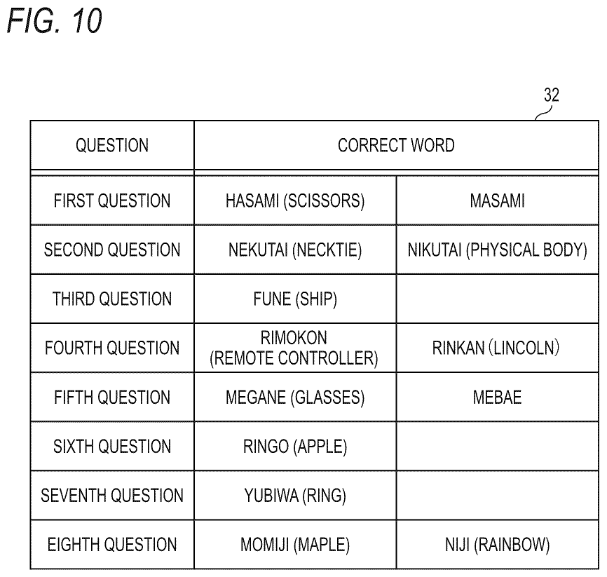

Here, the setting of the correct words in step S28 and step S36 will be described with reference to FIG. 10. As shown in FIG. 10, the correct words are set as a correct answer list 32 and stored in the memory 22. First to eighth questions in the correct answer list 32 correspond to the first to eighth questions in the questioning list 31 shown in FIG. 6. In the correct answer list 32, a correct word “fune (ship)” for the third question, a correct word “ringo (apple)” for the sixth question, and a correct word “yubiwa (ring)” for the seventh question are the “words to be memorized” of the correct words set in step S28. In the correct answer list 32, correct words “hasami (scissors)” and “masami” for the first question, correct words “nekutai (necktie)” and “nikutai (physical body)” for the second question, correct words “rimokon (remote controller)” and “Lincoln” for the fourth question, correct words “megane (glasses)” and “mebae” for the fifth question, and correct words “momiji (maple)” and “niji (rainbow)” for the eighth question are the “words to be memorized” and the “repeated words” of the correct words set in step S36.

The correct words for the third, sixth, and seventh questions are the words to be memorized in the following cases. For example, the correct word is a word to be memorized when the word to be memorized is questioned and a word matching the word to be memorized is detected as a repeated word from a repeated voice of the examinee. In addition, for example, when a word to be memorized is questioned, a word different from the word to be memorized is detected as a repeated word from a repeated voice of the examinee, and thus the examinee is prompted to re-repeat the word to be memorized. At this time, the correct word is the word to be memorized when a word matching the word to be memorized is detected as a re-repeated word from a re-repeated voice of the examinee. In addition, for example, when a word to be memorized is questioned, a word different from the word to be memorized is detected as a repeated word from a repeated voice of the examinee, and thus the examinee is prompted to re-repeat the word to be memorized. At this time, the correct word is the word to be memorized when a word different from both the word to be memorized and the repeated word is detected as a re-repeated word from a re-repeated voice of the examinee.

Specifically, the correct word for the third question (sixth question, seventh question) is the word to be memorized in the following cases. For example, when “fune (ship)” (“ringo (apple)”, “yubiwa (ring)”) is questioned, and a word matching “fune (ship)” (“ringo (apple)”, “yubiwa (ring)”) is detected as a repeated word from a repeated voice of the examinee, the correct word is “fune (ship)” (“ringo (apple)”, “yubiwa (ring)”). In addition, for example, when “fune (ship)” (“ringo (apple)”, “yubiwa (ring)”) is questioned, a word “une (ridge)” (“shingo”, “kubiwa (collar)”) is detected as a repeated word from a repeated voice of the examinee, and thus the examinee is prompted to re-repeat the word to be memorized. At this time, the correct word is “fune (ship)” (“ringo (apple)”, “yubiwa (ring)”) when a word matching “fune (ship)” (“ringo (apple)”, “yubiwa (ring)”) is detected as a re-repeated word from a re-repeated voice of the examinee. In addition, for example, when “fune (ship)” (“ringo (apple)”, “yubiwa (ring)”) is questioned, a word “une (ridge)” (“shingo”, “kubiwa (collar)”) is detected as a repeated word from a repeated voice of the examinee, and thus the examinee is prompted to re-repeat the word to be memorized. At this time, the correct word is “fune (ship)” (“ringo (apple)”, “yubiwa (ring)”) when a word “tsune” (“tango”, “naniwa”) is detected as a re-repeated word from a re-repeated voice of the examinee.

The correct words for the first question, the second question, the fourth question, the fifth question, and the eighth question are the words to be memorized and the repeated words in the following cases. For example, when a word to be memorized is questioned, a word different from the word to be memorized is detected as a repeated word from a repeated voice of the examinee, and thus the examinee is prompted to re-repeat the word to be memorized. At this time, the correct word is the word to be memorized and the repeated word when a word matching the repeated word is detected as a re-repeated word from a re-repeated voice of the examinee.

Specifically, the correct words for the first question (second question, fourth question, fifth question, eighth question) are the word to be memorized and the repeated word in the following cases. For example, when “hasami (scissors)” (“nekutai (necktie)”, rimokon (remote controller), “megane (glasses)”, “momiji (maple)”) is questioned, a word “masami” (“nikutai (physical body)”, “Lincoln”, “mebae”, “niji (rainbow)”) is detected as a repeated word from a repeated voice of the examinee, and thus the examinee is prompted to re-repeat the word to be memorized. At this time, the correct words are “hasami (scissors)” (“nekutai (necktie)”, rimokon (remote controller), “megane (glasses)”, “momiji (maple)”) and “masami” (“nikutai (physical body)”, “Lincoln”, “mebae”, “niji (rainbow)”) when a word matching “masami” (“nikutai (physical body)”, “Lincoln”, “mebae”, “niji (rainbow)”) is detected as a re-repeated word from a re-repeated voice of the examinee.

### <Training Process in Step S12>

When the questioning process in step S11 ends, the processor 21 executes the training process of reproducing content different from the cognitive function test in order to apply a load on the cognition of the examinee. That is, the training process is a training that is performed so that the examinee who memorizes the word to be memorized in the questioning process is not asked to answer the memorized word immediately, but is asked to answer after a little time.

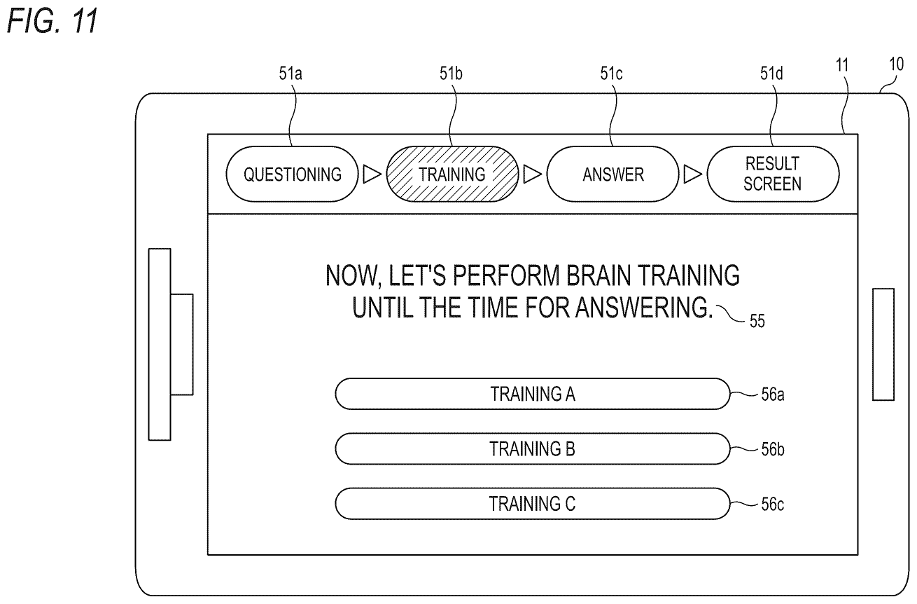

When the process shifts from the questioning process to the training process, as shown in FIG. 11, the processor 21 displays a training mark 51b for notifying that the current process is the training process, and displays a comment 55 such as “NOW, LET'S PERFORM BRAIN TRAINING UNTIL THE TIME FOR ANSWERING”. The training is configured such that the examinee may freely select one of trainings A, B, and C, for example. The processor 21 displays selection buttons 56a to 56c for selecting a type of training.

### <Answer Reception Process in Step S13>

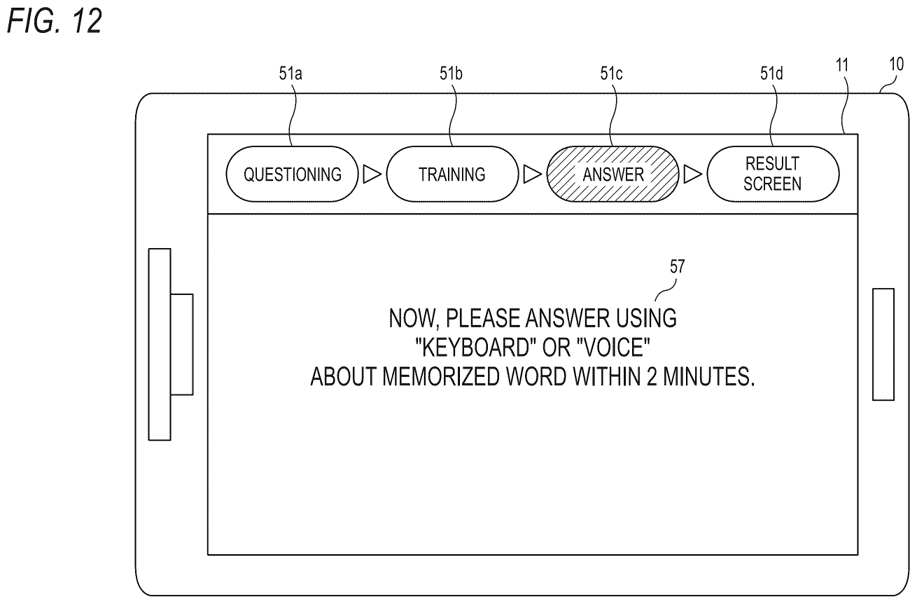

When the training process in step S12 ends, the processor 21 executes the answer reception process of causing the examinee to utter the questioned word to be memorized. When the process shifts from the training process to the answer reception process, as shown in FIG. 12, the processor 21 displays an answer mark 51c for notifying that the current process is the answer reception process, and displays a comment 57 such as “NOW, PLEASE ANSWER USING “KEYBOARD” OR “VOICE” WITHIN 2 MINUTES ABOUT MEMORIZED WORD”. Accordingly, reception of the answer is started.

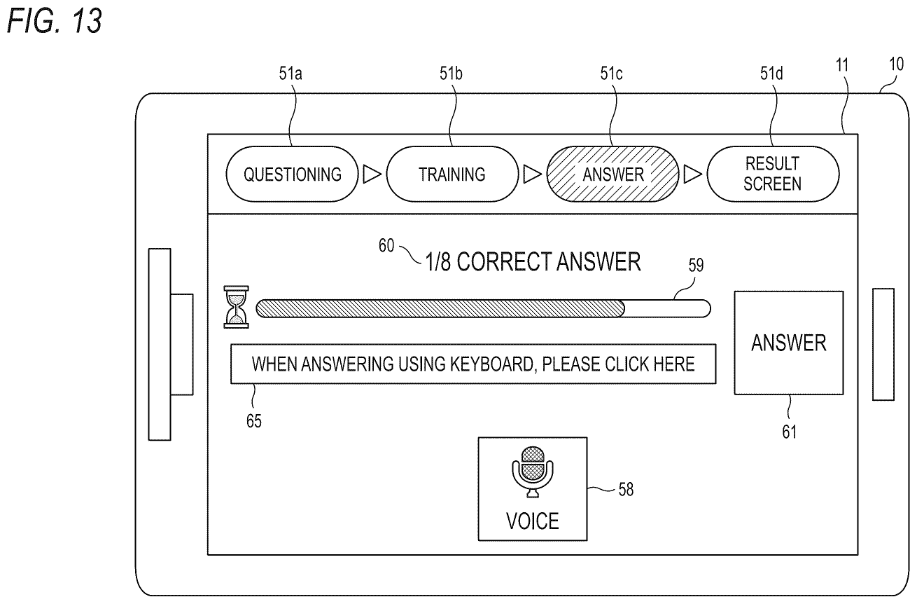

Subsequently, the processor 21 displays an answer reception image as shown in FIG. 13. A voice mark 58 is displayed on the answer reception image of FIG. 13, indicating that an answer by voice is currently able to be received. In addition, the processor 21 displays an elapsed time bar 59 indicating elapse of an answering time, and a correct answer mark 60 indicating the number of correct answers up to a present time (one of the eight questions is answered correctly).

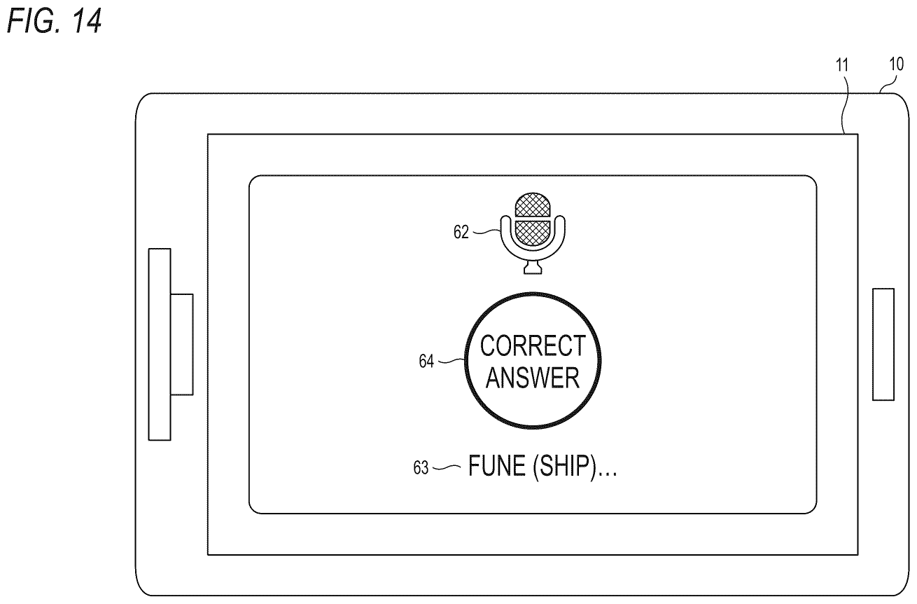

On a screen on which the answer reception image is displayed, the examinee touches an answer button 61 when answering. When the answer button 61 is touched, the processor 21 shifts the display of the display screen 11 to an answer determination image as shown in FIG. 14. However, at the beginning of the shift to the answer determination image, only a microphone mark 62 is displayed on the display screen 11 to indicate an answer acceptance state. In this state, for example, it is assumed that the examinee utters “fune (ship)” and a word “fune (ship)” is detected from a voice uttered by the examinee. In this case, the word “fune (ship)” is included in the plurality of questioned words to be memorized (see FIG. 6), and thus as shown in FIG. 14, a detected correct word (uttered memorized word) 63 and a correct answer mark 64 are displayed. On the other hand, when a word other than the uttered memorized word is detected from a voice uttered by the examinee, it is determined that the answer is incorrect, and the detected incorrect word and an incorrect answer mark are displayed. In addition, for example, when correct words are set as in the correct answer list 32 shown in FIG. 10, in a case of the word to be memorized “hasami (scissors)” questioned in the first question, when “hasami (scissors)” or “masami” is detected as a uttered memorized word from a voice uttered by the examinee, “hasami (scissors)” or “masami” and the correct answer mark are displayed as in the screen of FIG. 14.

The examinee may also answer using a keyboard input instead of the answer by voice. In a case of keyboard input, a keyboard switching button 65 is touched on the screen of FIG. 13. Accordingly, a software keyboard is displayed on the display screen 11, and thus it is possible to answer using the keyboard.

### <Result Output Process in Step S14>

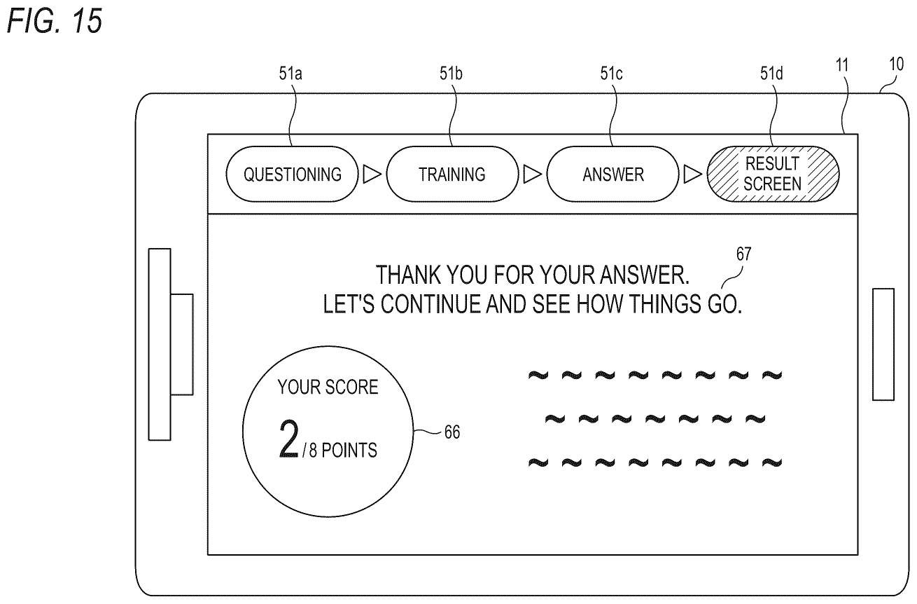

When the answer reception process in step S13 ends, the processor 21 executes the result output process for notifying a test result. When the process shifts from the answer reception process to the result output process, as shown in FIG. 15, the processor 21 displays a result screen mark 51d for notifying that the current process is the result output process, and displays a test result 66 indicating that two of the eight questions were answered correctly, and a comment 67 such as “THANK YOU FOR YOUR ANSWER. LET'S CONTINUE AND SEE HOW THINGS GO.”.

In the above embodiment, a case has been described in which the words to be memorized that are to be questioned are set in advance, for example, as shown in FIG. 6, but the present disclosure is not limited thereto. For example, the words to be memorized that are to be questioned may be freely selected by the processor 21 for each question from a plurality of questioning candidate words prepared in advance.

As described above, according to the cognitive function testing device 1, based on three types of words including the repeated word detected from the repeated voice of the examinee in addition to the questioned word to be memorized and the uttered memorized word detected from the uttered voice of the examinee, the test result of the cognitive function is output.

For example, according to the cognitive function testing device 1, it is determined that the answer is correct not only when the questioned word to be memorized matches the uttered memorized word detected from the uttered voice of the examinee, but also when the uttered memorized word matches the repeated word detected from the repeated voice of the examinee. Therefore, for example, even if a word detected when the examinee repeats the questioned word to be memorized does not match the word to be memorized due to characteristics of the pronunciation of the examinee or characteristics of a voice recognition process, it is possible to determine that the answer is correct if the examinee may utter the repeated word as the uttered memorized word, and thus it is possible to improve the test accuracy.

According to the cognitive function testing device 1, in a case where even if the repeated word detected from the repeated voice of the examinee does not match the questioned word to be memorized, the re-repeated word detected from the re-repeated voice of the examinee matches the repeated word, it is determined that the answer is correct when the uttered memorized word detected from the uttered voice of the examinee matches the repeated word. Therefore, for example, in a case where when “hasami (scissors)” is questioned, the word “masami” is detected as the repeated word from the repeated voice of the examinee, and when the examinee is prompted to re-repeat the word to be memorized, the word “masami” matching the repeated word is detected as the re-repeated word from the re-repeated voice of the examinee, and at the time of determination, when “masami” matching the repeated word is detected as the uttered memorized word from the uttered voice of the examinee, it is possible to determine that the answer “masami” is correct. Therefore, the test accuracy is improved.

According to the cognitive function testing device 1, in a case where the repeated word detected from the repeated voice of the examinee does not match the questioned word to be memorized, and the re-repeated word detected from the re-repeated voice of the examinee does not match the repeated word, it is not determined that the answer is correct even if the uttered memorized word detected from the uttered voice of the examinee matches the repeated word. Therefore, for example, in a case where when “fune (ship)” is questioned, the word “une (ridge)” is detected as the repeated word from the repeated voice of the examinee, and when the examinee is prompted to re-repeat the word to be memorized, the word “fune (ship)” matching the word to be memorized is detected as the re-repeated word from the re-repeated voice of the examinee, or in a case where the word “tsune”, which does not match either the word to be memorized or the repeated word, is detected as the re-repeated word from the re-repeated voice of the examinee, and at the time of determination, it is possible to determine that the answer “une (ridge)” is incorrect even if “une (ridge)” matching the repeated word is detected as the uttered memorized word from the uttered voice of the examinee. Therefore, the test accuracy is improved.

According to the cognitive function testing device 1, at the time of selecting the word to be memorized in the subsequent questioning process, the word to be memorized is selected based on the repeated word detected in the questioning process before the subsequent questioning process. Therefore, for example, the word to be memorized in the subsequent questioning process may be selected so as not to overlap with the repeated word detected in the previous questioning process, so that the test accuracy may be improved.

According to the cognitive function testing device 1, when the word different from the word to be memorized that is questioned in the previous questioning process is selected as the word to be memorized to be questioned in the subsequent questioning process, the word may be selected by being changed to the word in the same category as the word to be memorized set in advance for the subsequent questioning process. Therefore, it is possible to prevent a question that is completely different from that set in advance from being questioned, and to improve the test accuracy.

According to the cognitive function testing device 1, when the repeated word detected in the previous questioning process is different from the word to be memorized, it is possible to select a word in consideration of the number of characters as the word to be memorized in the subsequent questioning process. Therefore, for example, it is possible to select a word that is unlikely to be erroneously recognized (for example, having a large number of characters) even for an examinee who is likely to perform an erroneous recognition, and to improve the test accuracy.

According to the cognitive function testing device 1, it is possible to select the word to be memorized in the questioning process based on the history information that is related to the cognitive function test and stored in association with each examinee. Therefore, it is possible to exclude a word that is likely to be erroneously pronounced from the candidates of the word to be memorized for the examinee, and it is possible to question an appropriate word and to improve the test accuracy.

According to the cognitive function testing device 1, the training process can be executed between the questioning process and the answer reception process, and thus it is possible to apply an appropriate load on the cognition of the examinee, and to further improve the test accuracy.

### § 4 Modifications

Although the embodiment of the present invention has been described in detail above, the above description is merely an example of the present invention in all respects. Various improvements and modifications may be made without departing from the scope of the present invention. For example, the following changes are possible. In the following description, the same components as those of the above embodiment are denoted by the same reference signs, and the description of the same points as in the above embodiment is omitted as appropriate. The following modifications may be combined as appropriate.

### Modification 1

### <Modification of Questioning Process>

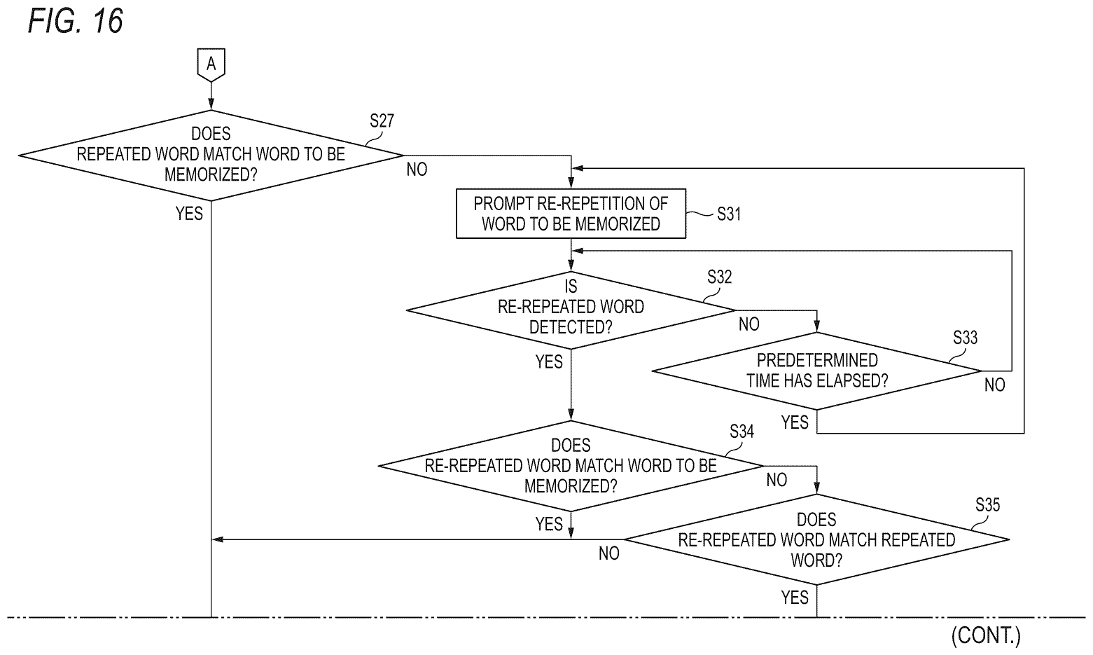

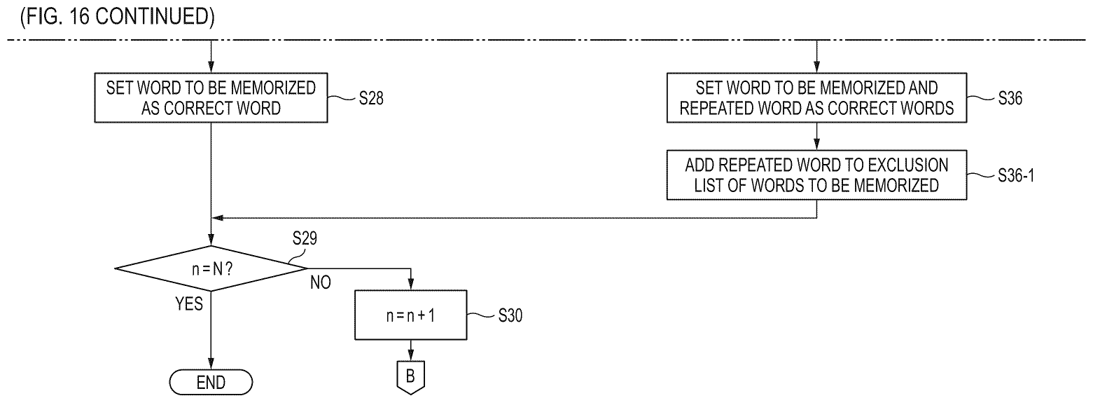

A modification of the questioning process will be described with reference to a flowchart of FIG. 16. As shown in FIG. 16, in a questioning process of the modification, each process from step S27 to step S36 is the same as each process from step S27 to step S36 of the questioning process shown in FIG. 5. Therefore, the description of the processes of these steps will be omitted.

After setting the word to be memorized and the repeated word as the correct words in step S36, the processor 21 adds the set repeated word to an exclusion list of the words to be memorized (step S36-1). That is, the processor 21 sets the repeated word that is set as the correct word so as not to be questioned in the subsequent questioning process in the examination of the examinee. Accordingly, during the reading of the words to be memorized in step S22 of FIG. 4, a word listed in the exclusion list is not selected. Therefore, the word to be memorized in the subsequent questioning process may be selected so as not to overlap with the repeated word detected in the previous questioning process, and the test accuracy may be improved.

### Modification 2

### <Modification of Processor (Controller) 21>

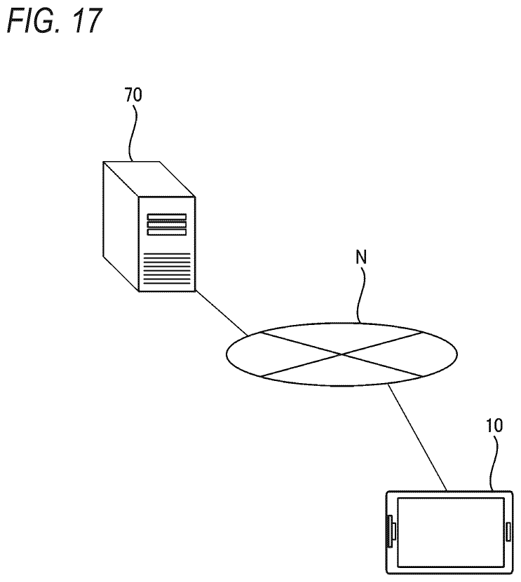

A modification of the processor (controller) 21 will be described with reference to FIG. 17. In the above embodiment, a case where the cognitive function testing device 1 is implemented by the processor 21 mounted on the information processing device 20 of the information terminal 10 has been described, but the present disclosure is not limited thereto. For example, as shown in FIG. 17, the cognitive function testing device 1 may be implemented by an external server 70 connectable to the information terminal 10 via a wide area network N such as the Internet. For example, the cognitive function test may be provided by the external server 70, and may be provided as a cognitive function test page that may be viewed using a web browser from the information terminal 10.

### § 5 Program

The cognitive function testing method described in the above embodiment may be implemented by executing a cognitive function testing program prepared in advance on a computer. The cognitive function testing program is stored in a computer-readable storage medium and is executed by being read from the storage medium. The cognitive function testing program may be provided in a form stored in a non-transitory storage medium such as a flash memory, or may be provided via a network such as the Internet. The computer that executes the cognitive function testing program may be provided in the cognitive function testing device, may be provided in an electronic device such as a smartphone, a tablet terminal, or a personal computer that may communicate with the cognitive function testing device, or may be provided in a server device that may communicate with the cognitive function testing device and the electronic device.

The present disclosure includes following configurations.
(1) A cognitive function testing device, including:
a controller configured to execute
a questioning process of outputting a first word to be memorized to an examinee, prompting the examinee to repeat the first word, and detecting a second word from a repeated voice of the examinee,
an answer reception process of prompting the examinee to utter a word memorized by the examinee through the questioning process, and detecting a third word from an uttered voice of the examinee, and
a result output process of outputting a result of determination based on the first word, the second word, and the third word.

According to (1), based on the first word to the third word including the second word detected from the repeated voice of the examinee in addition to the questioned first word to be memorized and the third word detected from the uttered voice of the examinee, it is possible to output a test result of a cognitive function, and thus test accuracy is improved.
(2) The cognitive function testing device according to (1), in which
in the determination, the controller determines that an answer is correct when the third word matches the first word.

According to (2), the test can be accurately performed by performing the determination based on the questioned first word to be memorized and the third word detected from the uttered voice of the examinee.
(3) The cognitive function testing device according to (1) or (2), in which
in the determination, the controller determines that an answer is correct when the third word matches the second word.

According to (3), when the third word detected from the uttered voice of the examinee matches the second word detected from the repeated voice of the examinee, the answer is also correct, so that the test accuracy is further improved.
(4) The cognitive function testing device according to (3), in which
in the questioning process, in response to the detected second word being different from the first word, the controller prompts the examinee to re-repeat the first word, and in a case where the second word is detected from a re-repeated voice of the examinee, the controller determines that an answer is correct when the third word matches the second word in the determination.

According to (4), even if the second word detected from the repeated voice of the examinee does not match the questioned first word to be memorized, in a case where the word detected from the re-repeated voice of the examinee matches the second word detected from the repeated voice of the examinee, it is determined that the answer is correct when the third word detected from the uttered voice of the examinee matches the second word detected from the repeated voice of the examinee, and thus the test accuracy is improved.
(5) The cognitive function testing device according to (4), in which
in a case where the second word is not detected from the re-repeated voice of the examinee, in the determination, the controller does not determine that an answer is correct when the third word matches the second word.

According to (5), in a case where the second word detected from the repeated voice of the examinee does not match the questioned first word to be memorized and the word detected from the re-repeated voice of the examinee does not match the second word detected from the repeated voice of the examinee, it is not determined that the answer is correct even if the third word detected from the uttered voice of the examinee matches the second word detected from the repeated voice of the examinee, and thus the test accuracy may be maintained.
(6) The cognitive function testing device according to any one of (1) to (5), in which
the controller is configured to
   sequentially execute the questioning process for a plurality of the first words, and
   select, in a plurality of the questioning processes, based on the second word detected in a first questioning process, the first word in a second questioning process subsequent to the first questioning process.

According to (6), the first word in the second questioning process is selected based on the second word detected in the first questioning process before the second questioning process, and thus the test accuracy is improved.
(7) The cognitive function testing device according to (6), in which
the controller is configured to select the first word in the second questioning process from words different from the second word detected in the first questioning process.

According to (7), a word different from the first word questioned in the first questioning process is selected as the first word to be questioned in the second questioning process, and thus the test accuracy is improved.
(8) The cognitive function testing device according to (6) or (7), in which
the first word in the plurality of the questioning processes is set in advance, and
the controller is configured to change the first word in the second questioning process to a word different from the second word detected in the first questioning process and in the same category as the first word set in advance in the second questioning process.

According to (8), when the word different from the first word questioned in the first questioning process is selected as the first word to be questioned in the second questioning process, the word is changed to a word in the same category as the first word set in advance for the second questioning process, and thus the test accuracy is improved.
(9) The cognitive function testing device according to any one of (6) to (8), in which
when the second word detected in the first questioning process is different from the first word, the controller selects the first word in the second questioning process from a plurality of word candidates based on the number of characters of the word candidate.

According to (9), when the second word detected in the first questioning process is different from the first word, a word in consideration of the number of characters is selected as the first word in the second questioning process, and thus the examinee can easily recognize the first word, and the test accuracy is improved.
(10) The cognitive function testing device according to any one of (1) to (9), in which
the controller is configured to
store history information based on a detection result of the second word in a past test in association with the examinee, and
select the first word in the questioning process based on the history information.

According to (10), the first word in the questioning process is selected based on the history information associated with each examinee, and thus it is possible to perform more appropriate questioning, and the test accuracy is improved.
(11) The cognitive function testing device according to any one of (1) to (10), in which
the controller is configured to execute a training process between the questioning process and the answer reception process to reproduce content that applies a load on cognition of the examinee.

According to (11), the training process is executed between the questioning process and the answer reception process, and thus the test accuracy is further improved. The training process of applying a load on the cognition is a process of reproducing content for causing the examinee to perform an active task. The content for causing the examinee to perform the active task is, for example, content such as a questionnaire, a quiz, or a game.
(12) A non-transitory computer-readable storage medium storing a cognitive function testing program for causing a processor of a cognitive function testing device to execute
a questioning process of outputting a first word to be memorized to an examinee, prompting the examinee to repeat the first word, and detecting a second word from a repeated voice of the examinee,
an answer reception process of prompting the examinee to utter a word memorized by the examinee through the questioning process, and detecting a third word from an utterance voice of the examinee, and
a result output process of outputting a determination result based on the first word, the second word, and the third word.

According to (12), based on the first word to the third word including the second word detected from the repeated voice of the examinee in addition to the questioned first word to be memorized and the third word detected from the uttered voice of the examinee, it is possible to output a test result of a cognitive function, and thus test accuracy is improved.

According to aspects of the present disclosure, it is possible to provide the cognitive function testing device and the cognitive function testing program that are capable of improving the test accuracy.

Although various embodiments have been described above, it goes without saying that the present invention is not limited to these examples. It is apparent to those skilled in the art that various changes or modifications may be conceived within the scope described in the claims, and it is understood that the changes or modifications naturally fall within the technical scope of the present invention. In addition, the components described in the above embodiment may be freely combined without departing from the spirit of the invention.

What is claimed is:

1. A cognitive function testing device, comprising:
a controller configured to execute
a questioning process of outputting a first word to be memorized to an examinee, prompting the examinee to repeat the first word, and detecting a second word from a repeated voice of the examinee,
an answer reception process of prompting the examinee to utter a word memorized by the examinee through the questioning process, and detecting a third word from an utterance voice of the examinee, and
a result output process of outputting a result of determination based on the first word, the second word, and the third word.

2. The cognitive function testing device according to claim 1, wherein
in the determination, the controller determines that an answer is correct when the third word matches the first word.

3. The cognitive function testing device according to claim 1, wherein
in the determination, the controller determines that an answer is correct when the third word matches the second word.

4. The cognitive function testing device according to claim 3, wherein
in the questioning process, in response to the detected second word being different from the first word, the controller prompts the examinee to re-repeat the first word, and in a case where the second word is detected from a re-repeated voice of the examinee, the controller determines that an answer is correct when the third word matches the second word in the determination.

5. The cognitive function testing device according to claim 4, wherein
in a case where the second word is not detected from the re-repeated voice of the examinee, the controller does not determine that an answer is correct when the third word matches the second word in the determination.

6. The cognitive function testing device according to claim 1, wherein
the controller is configured to
sequentially execute the questioning process for a plurality of the first words, and
select, in a plurality of the questioning processes, based on the second word detected in a first questioning process, the first word in a second questioning process subsequent to the first questioning process.

7. The cognitive function testing device according to claim 6, wherein
the controller is configured to select the first word in the second questioning process from words different from the second word detected in the first questioning process.

8. The cognitive function testing device according to claim 6, wherein
the first word in the plurality of the questioning processes is set in advance, and
the controller is configured to change the first word in the second questioning process to a word that is different from the second word detected in the first questioning process and that is in the same category as the first word set in advance in the second questioning process.

9. The cognitive function testing device according to claim 6, wherein
when the second word detected in the first questioning process is different from the first word, the controller selects the first word in the second questioning process from a plurality of word candidates based on the number of characters of the word candidate.

10. The cognitive function testing device according to claim 1, wherein
the controller is configured to
store history information based on a detection result of the second word in a past test in association with the examinee, and
select the first word in the questioning process based on the history information.

11. The cognitive function testing device according to claim 1, wherein
the controller is configured to execute a training process between the questioning process and the answer reception process to reproduce content that applies a load on cognition of the examinee.

12. A non-transitory computer-readable storage medium storing a cognitive function testing program for causing a processor of a cognitive function testing device to execute
a questioning process of outputting a first word to be memorized to an examinee, prompting the examinee to repeat the first word, and detecting a second word from a repeated voice of the examinee,
an answer reception process of prompting the examinee to utter a word memorized by the examinee through the questioning process, and detecting a third word from an utterance voice of the examinee, and
a result output process of outputting a result of determination based on the first word, the second word, and the third word.
